(19) United States
(12) Patent Application Publication
(10) Pub. No.: US 2008/0024532 A1
(43) Pub. Date: Jan. 31, 2008

(54) Methods and apparatus for inkjet printing system maintenance

(76) Inventor: Si-Kyoung Kim, Bundang (KR)

Correspondence Address: DUGAN & DUGAN, PC, 245 Saw Mill River Road, Suite 309, Hawthorne, NY, 10532, US

(21) Appl. No.: 11/493,297

(22) Filed: Jul. 26, 2006

(51) Int. Cl. B41J 29/38; B41J 2/165

(52) U.S. Cl. 347/9; 347/28; 347/33

(57) ABSTRACT

In a first aspect, a first method of inkjet printing system maintenance is provided. The first method includes the steps of (1) moving a maintenance unit to an inkjet print head that is in a position normally employed to dispense ink on a display object of a substrate; and (2) employing the maintenance unit to at least one of clean and calibrate the inkjet print head. Numerous other aspects are provided.

### CROSS-REFERENCE TO RELATED APPLICATIONS

The present application is related to U.S. patent application Ser. No. 11/019,930, filed Dec. 22, 2004 and titled “METHODS AND APPARATUS FOR ALIGNING PRINT HEADS” (Attorney Docket No. 9521-3/DISPLAY/AKT/RKK), which claims priority to commonly-assigned, co-pending U.S. Provisional Patent Application Ser. No. 60/625,550, filed Nov. 4, 2004 and titled “APPARATUS AND METHODS FOR FORMING COLOR FILTERS IN A FLAT PANEL DISPLAY BY USING INKJETTING”.

Further, the present application is related to U.S. patent application Ser. No. 11/123,502, filed May 4, 2005 and titled “DROPLET VISUALIZATION OF INKJETTING” (Attorney Docket No. AMAT/9705/DISPLAY/AKT/RKK).

Additionally, the present application is related to U.S. patent application Ser. No. 11/238,631, filed Sep. 29, 2005 and titled “METHODS AND APPARATUS FOR INKJET PRINT HEAD CLEANING” (Attorney Docket No. 9838/DISPLAY/INKJET/RKK).

Further, the present application is related to U.S. Patent Application Ser. No. 60/795,709, filed Apr. 29, 2006 and titled “METHODS AND APPARATUS FOR MAINTAINING INKJET PRINT HEADS USING PARKING STRUCTURES” (Attorney Docket No. 10648/L/DISPLAY/INKJET/RKK), which is a continuation-in-part of U.S. patent application Ser. No. 11/061,148, Attorney Docket No. 9521-5, filed on Feb. 18, 2005 and entitled “METHODS AND APPARATUS FOR INKJET PRINTING OF COLOR FILTERS FOR DISPLAYS” and which also claims priority from U.S. Provisional Patent Application Ser. No. 60/625,550, filed Nov. 4, 2004 and titled “APPARATUS AND METHODS FOR FORMING COLOR FILTERS IN A FLAT PANEL DISPLAY BY USING INKJETTING”.

All of the above-identified applications are hereby incorporated by reference herein in their entirety.

### FIELD OF THE INVENTION

The present invention relates generally to inkjet printing systems employed during flat panel display formation, and is more particularly concerned with methods and apparatus for inkjet printing system maintenance.

### BACKGROUND

The flat panel display industry has been attempting to employ inkjet printing to manufacture display devices, in particular, color filters. One problem with effective employment of inkjet printing is that it is difficult to inkjet ink or other material accurately and precisely on a substrate while having high throughput.

The accuracy of an inkjet printing system may be influenced by inks drying on the print heads as well as the precision of the physical components used in constructing the system and the degree to which corrections are applied to the system to accommodate a collective error effect of aggregating multiple components that individually may be within tolerances. In some cases, as a system wears or is subjected to stress or climatic changes, the accuracy of the system may decline. Thus, what is needed are systems and methods for efficiently and automatically cleaning and calibrating key components of an inkjet print system, including the inkjet print heads. What is further needed are such systems and methods that do not negatively impact system throughput.

### SUMMARY OF THE INVENTION

In a first aspect of the invention, a first method of inkjet printing system maintenance is provided. The first method includes the steps of (1) moving a maintenance unit to an inkjet print head that is in a position normally employed to dispense ink on a display object of a substrate; and (2) performing maintenance to the inkjet print head selected from the group including cleaning the inkjet print head, calibrating the inkjet print head, and combinations thereof.

In a second aspect of the invention, a first apparatus for inkjet printing is provided. The first apparatus includes (1) a bridge positioned over a substrate support stage; (2) a plurality of inkjet print heads coupled to the bridge; and (3) a maintenance unit movable below the inkjet print heads, the maintenance unit having one or more stations selected from the group including a cleaning station, a calibration station and combinations thereof.

In a third aspect of the invention, a first system for inkjet printing apparatus maintenance is provided. The first system includes (1) a substrate support stage; and (2) an inkjet printing apparatus coupled to the substrate support stage and, having (a) a bridge positioned over the substrate support stage; (b) a plurality of inkjet print heads coupled to the bridge; and (c) a maintenance unit movable below the inkjet print heads, the maintenance unit having one or more stations selected from the group including a cleaning station, a calibration station and combinations thereof. Numerous other aspects are provided, as are systems and apparatus in accordance with these other aspects of the invention.

Other features and aspects of the present invention will become more fully apparent from the following detailed description, the appended claims and the accompanying drawings.

### BRIEF DESCRIPTION OF THE FIGURES

FIG. 1 is a block diagram of a system for inkjet printing system maintenance in accordance with an embodiment of the present invention.

FIG. 2 is a top view of a first exemplary apparatus for inkjet printing system maintenance in accordance with an embodiment of the present invention.

FIG. 3 is a top view of a second exemplary apparatus for inkjet printing system maintenance in accordance with an embodiment of the present invention.

FIG. 4 illustrates a first exemplary method of inkjet printing system maintenance in accordance with an embodiment of the present invention.

FIG. 5 illustrates a second exemplary method of inkjet printing system maintenance in accordance with an embodiment of the present invention.

FIG. 6 illustrates an inkjet print head parking station in accordance with an embodiment of the present invention.

FIG. 7 illustrates an inkjet print head wiping station in accordance with an embodiment of the present invention.

FIG. 8 illustrates an inkjet print head calibration system in accordance with an embodiment of the present invention.

FIG. 9 illustrates an inkjet droplet visualization system in accordance with an embodiment of the present invention.

### DETAILED DESCRIPTION

A system for manufacturing display devices using inkjet printing may include one or more print heads coupled to a print bridge. The system may further include a stage adapted to support a substrate below the print bridge. The print bridge and/or the stage may be movable to facilitate inkjet printing on the substrate. More specifically, during display device manufacturing, the print bridge and/or the stage may move to position a substrate supported on the stage directly below one or more of the print heads such that ink may be dispensed therefrom onto a display object formed on the substrate.

During display device manufacturing, the print heads may require maintenance. For example, nozzles of inkjet print heads may become clogged or otherwise obstructed by ink drying on or in the print heads. Therefore, an inkjet print head parking station may be employed to remove such ink from the print heads. The inkjet print head parking station may be adapted to provide a solvent shower or pool into which a print head may be dipped such that ink on the print head may be dissolved or washed away. Additionally or alternatively, a wiping station may be employed to remove the ink. The wiping station may be adapted to position and move a cleaning medium adjacent a nozzle plate of a print head such that ink may be removed from the nozzle plate.

Further, during display device manufacturing, one or more of the print heads may become misaligned or need to be calibrated. Therefore, additionally or alternatively, a print head calibration system may be employed to precisely calibrate a position and orientation control mechanism of the print head.

Further, during display device manufacturing, a consistency and precision with which droplets are dispensed from an inkjet print head onto display objects of the substrate may be affected such that the consistency and/or precision are not within an acceptable standard. Therefore, additionally or alternatively, a system for visualizing dispensed inkjet droplets may be employed to adjust the consistency and precision with which the droplets are dispensed.

However, in such system, maintenance units such as an inkjet print head parking station, wiping station, print head calibration system and/or inkjet droplet visualization system may be immobile (e.g., in a stationary position along an end of the print bridge or the perimeter of the stage). Therefore, a print head must be moved to the unit for maintenance. For example, the print head may be moved to the end of the print bridge for maintenance. While the print head is moved to the end of the print bridge, such print head may not be employed to manufacture display devices. Therefore, the time required to move the print head to the maintenance unit increases an overall display device processing time. Consequently, improved methods, apparatus and systems for manufacturing display devices are desired.

The present invention provides improved methods, apparatus and systems for manufacturing display devices (e.g., color filters). One or more of the maintenance units may be mounted on one or more platforms which are adapted to move below the one or more inkjet print heads while such print heads remain positioned to dispense ink. Thus, in the system of the present invention, rather than requiring the print heads to move from their printing positions (e.g., ink-dispensing positions), the maintenance units are moved to the print heads. Because the print heads remain in their printing positions during maintenance, display device manufacturing time is not consumed to move a print head to an end of the print bridge or to a perimeter of the stage. Therefore, display device manufacturing efficiency may be improved. In this manner, the present invention provides improved methods, apparatus and systems for manufacturing display devices.

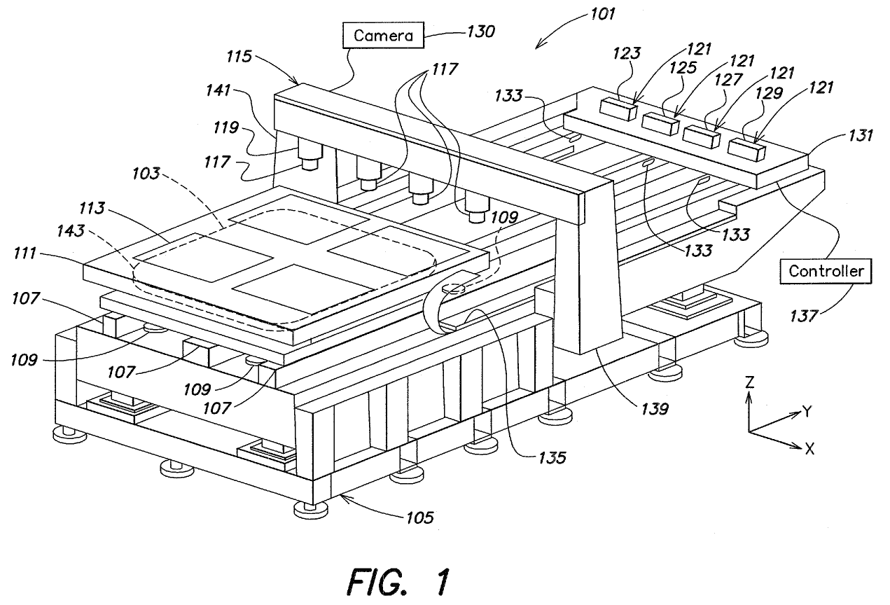

FIG. 1 is a schematic perspective diagram of a system 101 for inkjet printing system maintenance in accordance with an embodiment of the present invention. With reference to FIG. 1, the system 101 may include a stage 103 (shown in phantom) movably coupled to a frame 105. More specifically, the frame 105 may include and/or be coupled to one or more rails 107, and the stage 103 may include and/or be coupled to one or more features (e.g., rollers) 109 adapted to movably couple to the rails 107 such that the stage 103 may be adapted to move in a direction (e.g., in a y-axis direction) along the rails 107. The stage 103 may be adapted to support a substrate 111, such as a flat panel display or the like, thereon. The substrate 111 may include one or more display objects 113 formed thereon.

The system 101 may include a bridge 115 coupled to and/or included in the frame 105 such that as the stage 103 (and substrate 111 supported thereon) moves along the rails 107, the stage 103 and substrate 111 may pass below the bridge 115. One or more inkjet print heads 117 may be coupled to the bridge 115 and adapted to dispense ink onto a display object 113 of the substrate 111 as the substrate 111 passes thereunder. Each inkjet print head 117 may include and/or be coupled to a corresponding inkjet print head position and orientation control mechanism 119 adapted to adjust printhead position and/or orientation. Alternatively, the one or more inkjet print heads 117 may be coupled to a single inkjet print head position and orientation control mechanism 119.

In some embodiments, the inkjet print heads 117 may be cleaned and/or calibrated before inkjet printing (e.g., before dispensing ink onto substrate display objects 113). However, after or during inkjet printing one or more substrates 111, at least one inkjet print head 117 may require maintenance. For example, one or more nozzles of at least one inkjet print head 117 may become clogged or otherwise obstructed by ink drying on or in the inkjet print head 117. Therefore, such inkjet print head 117 may require cleaning. Additionally or alternatively, after or during inkjet printing one or more substrates 111, a calibration of at least one inkjet print head 117 may be adversely affected. Therefore, the position and orientation control mechanism 119 corresponding to the inkjet print head 117 may require calibration. Additionally or alternatively, the consistency and/or precision with which droplets of the ink are dispensed from the at least one inkjet print head 117 may need to be verified and possibly adjusted.

Therefore, the system 101 may include a plurality of maintenance units 121. For example, the system 101 may include at least one inkjet print head parking station (only one shown) 123. An inkjet print head parking station 123 may be adapted to provide a solvent shower or pool into which the inkjet print head 117 is dipped such that ink on the inkjet print head 117 may be removed. Details of the inkjet print head parking station are described in U.S. Patent Application Ser. No. 60/795,709, filed Apr. 29, 2006 and titled “METHODS AND APPARATUS FOR MAINTAINING INKJET PRINT HEADS USING PARKING STRUCTURES” (Attorney Docket No. 10648/L/DISPLAY/INKJET/RKK) which is hereby incorporated by reference herein in its entirety.

Additionally or alternatively, the system 101 may include at least one wiping station 125. A wiping station 125 may be adapted to position and move a cleaning medium adjacent the inkjet print head 117 such that ink may be removed from the inkjet print head 117. Details of the wiping station are described in U.S. patent application Ser. No. 11/238,631, filed Sep. 29, 2005 and titled “METHODS AND APPARATUS FOR INKJET PRINT HEAD CLEANING” (Attorney Docket No. 9838/DISPLAY/INKJET/RKK) which is hereby incorporated by reference herein in its entirety.

Additionally or alternatively, the system 101 may include at least one inkjet print head calibration system 127 (e.g., an upward viewing calibration imaging system) adapted to calibrate the position and orientation control mechanism 119 of the inkjet print head 117. Details of the inkjet print head calibration system 127 are described in U.S. patent application Ser. No. 11/019,930, filed Dec. 22, 2004 and titled “METHODS AND APPARATUS FOR ALIGNING PRINT HEADS” (Attorney Docket No. 9521-3/DISPLAY/AKT/RKK) which is hereby incorporated by reference herein in its entirety.

Additionally or alternatively, the system 101 may include at least one inkjet droplet visualization system 129. An inkjet droplet visualization system 129 may be adapted to adjust at least one of the consistency and precision with which droplets of the ink are dispensed from the inkjet print head 117. Details of the inkjet drop visualization system 129 are described in U.S. patent application Ser. No. 11/123,502, filed May 4, 2005 and titled “DROPLET VISUALIZATION OF INKJETTING” (Attorney Docket No. AMAT/9705/DISPLAY/AKT/RKK).

The maintenance units 121 described above are exemplary. Therefore, the system 101 may include a larger or smaller number of and/or different types of maintenance units 121. Further, the system 101 may include one or more cameras 130 (only one shown) or similar monitoring means adapted to determine whether an inkjet print head 117 requires cleaning, calibration and/or other maintenance. In some embodiments, the one or more cameras 130 may be positioned on the print bridge 115. However, the cameras 130 may be positioned elsewhere. Further, in some embodiments, cameras included in the inkjet print head parking station 123, inkjet print head calibration system 127 and/or inkjet droplet visualization system 129 may serve as the one or more cameras 130.

A maintenance unit included in some existing systems for manufacturing display devices may be immobile. For example, the maintenance unit may be in a stationary position along an end of the print bridge or the perimeter of the stage. However, in the present system 101, the one or more maintenance units 121 may move. For example, the system 101 may include one or more platforms 131 movably coupled to the frame 105. The platform 131 may be similar to the stage 111. More specifically, the platform 131 may include and/or be coupled to one or more features (e.g., rollers) 133 adapted to movably couple to the rails 107 such that the platform 131 may be adapted to move in a direction (e.g., in a y-axis direction) along the rails 107. Such direction may be approximately the same as the direction in which the substrate 111 is moved by the stage 103 during display device manufacturing. In some embodiments, the system 101 may include a track 135 on which the features 133 move. However, the platform 131 may be movably coupled to the frame 105 in a different manner. In some embodiments, the platform 131 may be movably coupled to a different component of the system 101. In some other embodiments, the platform 131 may not be coupled to a component of the system 101. For example, the platform 131 may be a free standing support that moves relative the inkjet print heads 117. Although the platform 131 and stage 103 are shown as separate components, in some embodiments, the platform 131 may be integrated with the stage 103 (e.g., may be a portion of the stage 103).

The platform 131 may be adapted to couple to the one or more maintenance units 121, such as the at least one inkjet print head parking station 123, at least one wiping station 125, at least one inkjet print head calibration system 127, at least one inkjet droplet visualization system 129, etc. For example, the platform 131 may support the one or more maintenance units thereon. The one or more maintenance units 121 may be coupled (e.g., fixedly) to the platform 131 using nuts and bolts, screws or any other suitable coupling means. The platform 131 may be formed from any suitable material. In some embodiments, the platform 131 may be adapted to move in one or more of the x-axis, y-axis and z-axis directions. Additionally or alternatively, the platform 131 may be adapted to rotate. In this manner, the system 101 includes movable (e.g., in a direction approximately the same as the direction in which the substrate 111 is moved during display device manufacturing) maintenance units 121 for an inkjet printing system. However, in some embodiments, the platform 131 (and maintenance units 121 coupled thereto) may move in a direction different from the direction in which the stage moves. For example, in some embodiments, the platform 131 and maintenance units 121 coupled thereto may be positioned under the bridge at a level below that of the stage 103 such that the platform 131 and maintenance units 121 do not obstruct the stage 103 (and substrate supported thereon 111) during display device manufacturing. In such embodiments, the platform 131 may be adapted to move in the z-axis direction to position the units 121 for maintenance.

A controller 137 may be coupled to the platform 131 and control movement thereof. The controller 137 may receive signals from the one or more cameras 130 indicating whether one or more inkjet print heads 117 require cleaning and/or calibration, and control movement of the platform 131 based thereon such that an appropriate maintenance unit 121 may be moved or brought to an inkjet print head 117 requiring such maintenance. In this manner, the one or more maintenance units 121 may be moved to any inkjet print head 117 requiring maintenance when such inkjet print head 117 is in a printing position (e.g., in a position normally employed to deposit ink onto display objects 113 of the substrate 111). Thus, the system 101 may not require an inkjet print head 117 to move to an edge 139, 141 of the print bridge 115 or a perimeter 143 of the stage 103 for maintenance. A time required for such movement would increase processing time required to manufacture display devices. However, because the inkjet print heads 117 may remain positioned to deposit ink onto display objects 113 of the substrate 111 during maintenance, the system 101 may avoid such a time required to move the inkjet print head 117 to an end 139, 141 of the print bridge 115 or a perimeter 143 of the stage 103, during which the inkjet print head 117 may not be employed to manufacture display devices.

The controller 137 may be any suitable computer or computer system, including, but not limited to, a mainframe computer, a minicomputer, a network computer, a personal computer, and/or any suitable processing device, component, or system. Likewise, the controller 137 may comprise a dedicated hardware circuit or any suitable contribution of hardware and software. System components such as the platform 131, one or more maintenance units 121, features 133, track 135, controller 137, inter alia, may serve as an apparatus for inkjet printing system maintenance.

Thus, in the system 101, maintenance units 121 may be mounted on a movable platform 131 that may travel in the print direction (e.g., in the y-axis direction) toward the inkjet print heads 117 to allow maintenance to be performed on the print heads 117. For example, the movable maintenance units 121 may be positioned under the bridge 115 to allow the print heads 117 to be cleaned and/or calibrated. The movable maintenance units 121 may improve processing performance by allowing the print heads 117 to remain in a printing position during maintenance (as opposed to other systems in which print heads having to move (e.g., in an x-axis direction) to various fixed-location maintenance stations around the perimeter of a stage).

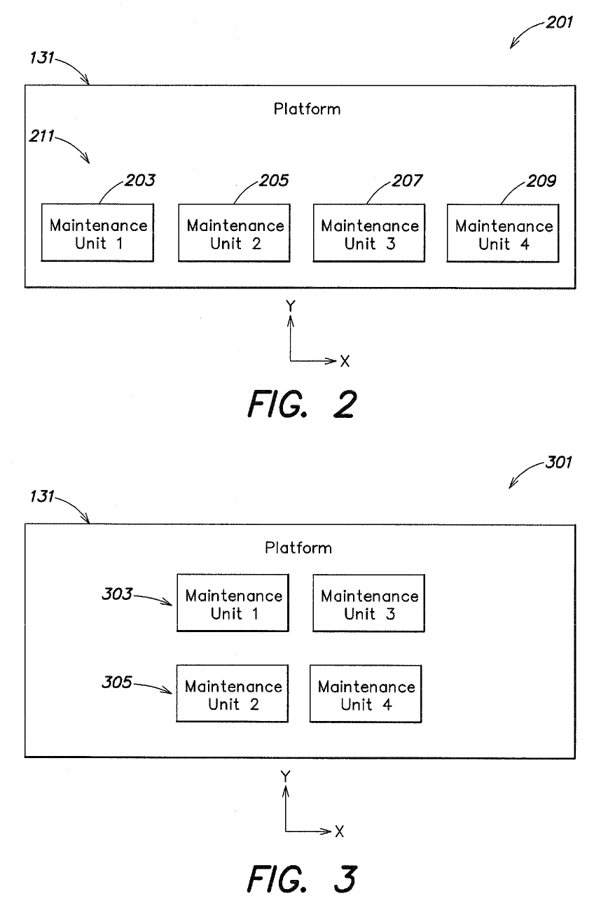

FIG. 2 is a top view of a first exemplary apparatus 201 for inkjet printing system maintenance in accordance with some embodiments of the present invention. With reference to FIG. 2, in the first exemplary apparatus 201, four maintenance units 203, 205, 207, 209 may be positioned in a row 211 (e.g., along the x-axis), such that when the platform 131 moves such maintenance units 203, 205, 207, 209 below the one or more inkjet print heads 117, each of the four maintenance units 203, 205, 207, 209 may perform maintenance on a corresponding inkjet print head 117 at the same time. Each maintenance unit 121 may be of a different type than the remaining maintenance units. For example, the first maintenance unit 203 may be an inkjet print head parking station 123, the second maintenance unit 205 may be a wiping station 125, the third maintenance unit 207 may be an inkjet print head calibration system 127 and the fourth maintenance unit 209 may be a droplet visualization system 129. Although four maintenance units 203, 205, 207, 209 are described above, the row 211 may include a larger or smaller number of maintenance units 121. For example, the sequence of the first through fourth maintenance units 203, 205, 207, 209 may be repeated in the row 211 a plurality of times.

Further, in some embodiments, the first exemplary apparatus 201 may include a second row (not shown) of maintenance units 121 which are aligned (e.g., in the y-axis direction) with respective maintenance units 203, 205, 207, 209 of the first row 211. However, the maintenance units 121 in the second row may be positioned such that the maintenance units 121 are staggered with the same types of maintenance units 121 in the first row 211. For example, the second row may include a wiping station 125 aligned with the inkjet print head parking station 123 of the first row 211, an inkjet print head calibration system 127 aligned with the wiping station 125 of the first row 211, a droplet visualization system 129 aligned with the inkjet print head calibration system 127 of the first row and an inkjet print head parking station 123 aligned with the droplet visualization system 129 of the first row 211.

FIG. 3 is a top view of a second exemplary apparatus 301 for inkjet printing system maintenance in accordance with an embodiment of the present invention. With reference to FIG. 3, in the second exemplary apparatus 301, different types of maintenance units 121 may be clustered. More specifically, a first row 303 (e.g., along the x-axis) may include an inkjet print head parking station 123 and a wiping station 125, and a second row 305 may include an inkjet print head calibration system 127 and a droplet visualization system 129. Such cluster of maintenance units 121 may be repeated on the platform 131 in one of a plurality of ways. Thus, each type of maintenance unit 121 may be proximate an inkjet print head 117 when the platform 131 is moved below the bridge 115. Consequently, any type of maintenance unit 121 may be quickly positioned to serve a row of inkjet print heads.

FIGS. 2 and 3 illustrate exemplary layouts of the maintenance units 121 on the platform 131. Therefore, the maintenance units 121 may be arranged on the platform 131 in a different manner. Although not pictured, the apparatus 201, 301 may include multiple platforms 131, each with one or more maintenance units 121.

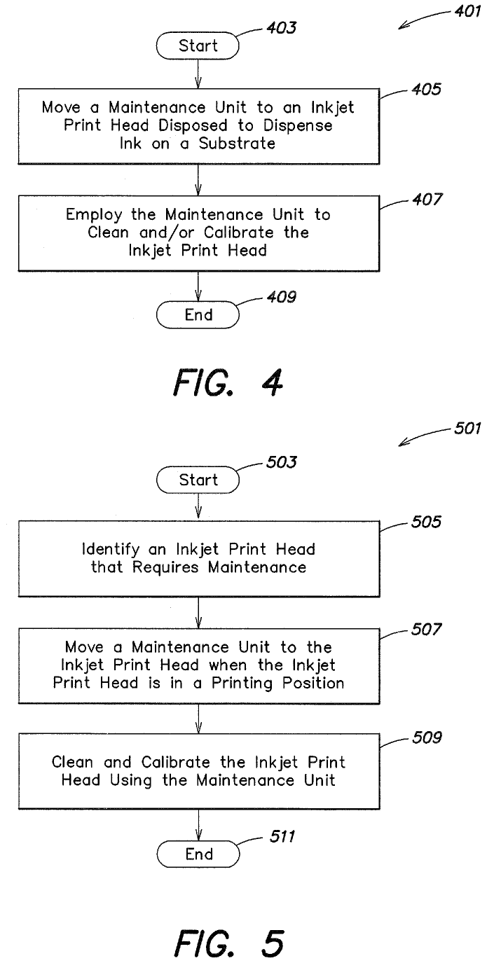

FIG. 4 illustrates a first exemplary method 401 of inkjet printing system maintenance in accordance with an embodiment of the present invention. With reference to FIG. 4, in step 403, the method 401 begins. In step 405, a maintenance unit 121 is moved to an inkjet print head 117 that is positioned to dispense ink on a display object 113 of the substrate 111. For example, the controller 137 may cause the platform 131 to move a maintenance unit 121 to an inkjet print head 117 that requires maintenance.

If the inkjet print head 117 requires cleaning, an inkjet print head parking station 123 may be moved to the inkjet print head 117 that requires maintenance. Alternatively or additionally, a wiping station 125 may be moved to the inkjet print head that requires maintenance. The platform 131 may be moved in an x-axis, y-axis and/or z-axis direction to move the maintenance unit 121 to the inkjet print head 117 such that the maintenance unit 121 may service the inkjet print head 117.

Alternatively or additionally, if the inkjet print head 117 requires calibration, an inkjet print head calibration system 127 may be moved to the inkjet print head 117 that requires maintenance. Alternatively or additionally, a droplet visualization system 129 may be moved to the inkjet print head 117 that requires maintenance.

By employing the platform 131 to move the maintenance units 121 to the inkjet print head 117 when the inkjet print head 117 is positioned to dispense ink on a display object 113 of the substrate 111, the inkjet print heads 117 may remain positioned to deposit ink onto display objects 113 of the substrate 111. Because the inkjet print heads 117 remain positioned to deposit ink onto display objects 113 of the substrate 111 during maintenance, the system 101 may avoid a time required to move the inkjet print head 117 to an end 139, 141 of the print bridge 115 or a perimeter 143 of the stage 103, during which the print head 117 may not be employed to manufacture display devices. Such a timesavings may reduce an overall display device processing time (compared to display device processing systems which employ immobile maintenance units). Consequently, the present method 401 may improve display device processing throughput.

In step 407, the maintenance unit 121 may be employed to at least one of clean and calibrate the inkjet print head 117. For example, if an inkjet print head parking station 123 is moved to the inkjet print head 117, a solvent shower or pool provided by the parking station 123 may be employed to clean the print head 117. The controller 137 may cause the platform 131 to move the inkjet print head parking station 123 such that the inkjet print head 117 may be dipped into the solvent shower, and some, most or all of the ink clogging or otherwise obstructing nozzles of the inkjet print head 117 may be removed by the solvent shower.

Additionally or alternatively, a wiping station 125 may be moved to the inkjet print head 117. More specifically, the controller 137 may cause the platform 131 to move the wiping station 125 such that the cleaning medium of the wiping station 125 may be positioned and moved adjacent the inkjet print head 117 such that ink may be removed from the inkjet print head 117. In some embodiments, a plurality of maintenance units 121 employed to clean an inkjet print head 117 may be proximately positioned. For example, an inkjet print head parking station 123 may be positioned on the platform 131 proximate a wiping station 125. Therefore, the inkjet print head 117 may be dipped into the solvent shower provided by the inkjet print head parking structure 123. Thereafter, before the solvent applied to the inkjet print head 117 by the inkjet print head parking station 123 evaporates, the wiping station 125 may quickly be moved to the inkjet print head 117 such that the cleaning medium of the wiping station 125 may be positioned and moved adjacent the inkjet print head 117 to remove ink from the inkjet print head 117. In this manner, such maintenance units 121 may effectively clean the inkjet print head 117. In the example above, the inkjet print head 117 is serviced by the inkjet print head parking station 123, and thereafter, by the wiping station 125. However, the inkjet print head 117 may be serviced by the maintenance units 121 in a different order. For example, in some embodiments, the inkjet print head 117 may be serviced by the wiping station 125, and thereafter, by the inkjet print head parking station 123.

Additionally or alternatively, if an inkjet print head calibration system 127 is moved to the inkjet print head 117, the inkjet print head calibration system 127 may calibrate the position and orientation control mechanism 119 of the inkjet print head 117. In this manner, such mechanism 119 may ensure the inkjet print head 117 is in a printing position (e.g., the inkjet print head 117 has a proper position and has a proper orientation to dispense droplets of ink onto display objects 113 of the substrate 111).

Additionally or alternatively, an inkjet droplet visualization system 129 may be moved to the inkjet print head 117. More specifically, the controller 137 may cause the platform 131 to move the inkjet droplet visualization system 129 such that the inkjet droplet visualization system 129 may adjust the consistency of droplets and/or precision with which such droplets of the ink are dispensed from the inkjet print head 117. In some embodiments, a plurality of maintenance units 121 employed to calibrate an inkjet print head 117 may be proximately positioned. For example, an inkjet print head calibration system 127 may be positioned on the platform 131 proximate an inkjet droplet visualization system 129. Therefore, the inkjet print head position and/or orientation may be adjusted such that the inkjet print head 117 is in a proper printing position. Thereafter, the inkjet droplet visualization system 129 may quickly be moved to the inkjet print head 117 such that the inkjet droplet visualization system 129 may adjust the consistency of droplets and/or precision with which such droplets of the ink are dispensed from the inkjet print head 117. In this manner, the inkjet print head 117 may quickly be calibrated.

Further, in some embodiments, at least one maintenance unit 121 for cleaning an inkjet print head 117 may be positioned proximate at least one maintenance unit 121 for calibrating an inkjet print head 117. In this manner, an inkjet print head 117 may quickly be cleaned and calibrated, and vice versa.

Thereafter, step 409 may be performed. In step 409, the method 401 ends. Through use of the first exemplary method 401, maintenance, such as cleaning or calibration, may be performed on one or more inkjet print heads 117 while the inkjet print heads 117 remain are in a printing position. Therefore, display device manufacturing time is not consumed to move an inkjet print head 117 to an end 139, 141 of the print bridge 115, a perimeter 143 of the stage 111 or another location. Therefore, display device manufacturing efficiency may be improved. In this manner, the present invention provides improved methods, apparatus and systems for manufacturing display devices.

FIG. 5 illustrates a second exemplary method 501 of inkjet printing system maintenance in accordance with an embodiment of the present invention. With reference to FIG. 5, in step 503, the method 501 begins. In step 505, an inkjet print head 117 that requires maintenance may be identified. For example, the one or more cameras 130 or other suitable monitoring means may determine that one or more inkjet print heads 117 require cleaning, calibration and/or other maintenance. The cameras 130 may detect that ink has dried on nozzles of an inkjet print head 117, that drops dispensed from an inkjet print head 117 are inconsistent (e.g., are of varying sizes and/or shapes), that ink is not precisely dropped onto display objects 113 of the substrate 111 and/or other operational conditions which may adversely affect display device manufacturing yield. The cameras 130 may send a signal to the controller 137 identifying one or more inkjet print heads 117 that require maintenance. In this manner, a plurality of inkjet print heads 117 that require maintenance may be identified.

In step 507, a maintenance unit 121 may be moved to the inkjet print head 117 when the inkjet print head 117 is in a printing position. For example, the controller 130 may cause the platform 131 to move such that one or more appropriate maintenance units 121 may be moved to the inkjet print heads 117 that require maintenance. The controller 130 may cause the platform 131 to move such that maintenance may be performed on a plurality of inkjet print heads 117 by respective maintenance units 121 concurrently. For example, an inkjet print head parking station 123 may be moved to a first inkjet print head, a wiping station 125 may be moved to a second inkjet print head, an inkjet print head calibration system 127 may be moved to a third inkjet print head and an inkjet droplet visualization system 129 may be moved to a fourth inkjet print head.

In step 509, the inkjet print head 117 may be cleaned and/or calibrated using the maintenance unit 121. For example, the inkjet print head parking station 123 may clean the first inkjet print head, the wiping station 125 may clean the second inkjet print head, the inkjet print head calibration system 127 may calibrate the third inkjet print head and the inkjet droplet visualization system 129 may calibrate the fourth inkjet print head concurrently.

After maintenance is performed on an inkjet print head 117 by a maintenance unit 121, one or more additional maintenance units 121 may be moved to the inkjet print head 117 to complete the maintenance (as described in steps 507 and 509). For example, after the above-described maintenance on the first through fourth inkjet print heads, the controller 137 may cause the platform 131 to move such that a wiping station 125 is moved to the first inkjet print head, an inkjet print head parking station 123 is moved to the second inkjet print head, an inkjet droplet visualization system 129 may be moved to the third inkjet print head and an inkjet print head calibration system 127 may be moved to the fourth inkjet print head. The wiping station 125 may clean the first inkjet print head, the inkjet print head parking station 123 may clean the second inkjet print head, the inkjet droplet visualization system 129 may calibrate the third inkjet print head and the inkjet print head calibration system 127 may calibrate the fourth inkjet print head concurrently. Further, if the first and/or second inkjet print heads require calibration, the platform 131 may cause one or more calibration maintenance units 127, 129 to move to such inkjet print heads. Similarly, if the third and/or fourth inkjet print heads require cleaning, the platform 131 may cause one or more cleaning maintenance units 123, 125 to move to such inkjet print heads. In some embodiments, the platform 131 may be adapted to allow the maintenance units 127, 129 to be rotated between the different print heads 117 and/or to move the maintenance units 127, 129 on the platform 131.

Thereafter, step 511 may be performed. In step 511, the method 501 ends. Through use of the second exemplary method 501, maintenance, such as cleaning and/or calibration, may be performed on one or more inkjet print heads 117 (e.g., concurrently) while the inkjet print heads 117 are in printing positions. Therefore, display device manufacturing time is not consumed to move one or more inkjet print heads 117 to an end 139, 141 of the print bridge 115 or to a perimeter 143 of the stage 103. Therefore, display device manufacturing efficiency may be improved. In this manner, the present invention provides improved methods, apparatus and systems for manufacturing display devices.

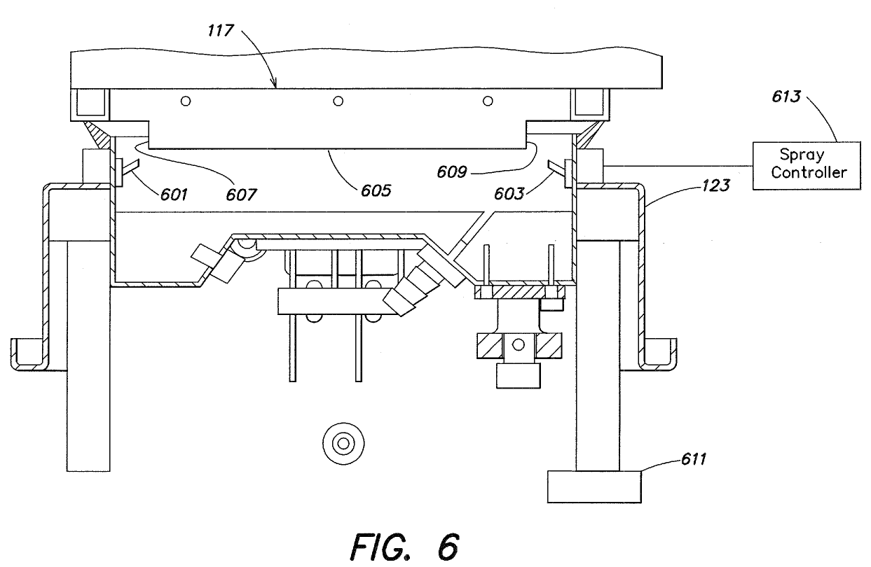

FIG. 6 illustrates an inkjet print head parking station 123 in accordance with an embodiment of the present invention. With reference to FIG. 6, an exemplary cross-sectional front view of a print head 117 parked in an example parking structure 123 is depicted. The parking structure 123 may be coupled to the platform 131 and moved to the print head 117 thereon. The example parking structure 123 includes sprayers 601, 603 adapted to spray solvent and/or surface treatment chemicals onto a nozzle plate 605 of the print head 117 without getting solvent on the sides of the print head 117. It is noted that while only two sprayers 601, 603 are shown in the particular example of FIG. 6, the parking structure 123 may include any number of sprayers (e.g., 1, 2, 3, 4, 5, 6, 7, etc.) and the sprayers 601, 603 may be situated with respect to the nozzles of the print head 117 in a number of different arrangements. In the arrangement depicted in FIG. 6, the sprayers 601, 603 are positioned proximate to and slightly below opposite lateral ends 607, 609 of the nozzle plate 605 and configured to direct a stream of solvent with a small angular spread. The sprayers 601, 603 are also coupled to a spray controller 613. Spray controller 613 may be adapted to control motion of and provision of fluid to the sprayers 601, 603.

The parking structure 123 may be adapted to move vertically to engage and disengage a print head 117. In some embodiments, an actuator 611 (e.g., a pneumatic or hydraulic cylinder either alone or in conjunction with a cam or up/down rotation shaft) may be employed to raise and lower the parking structure 123.

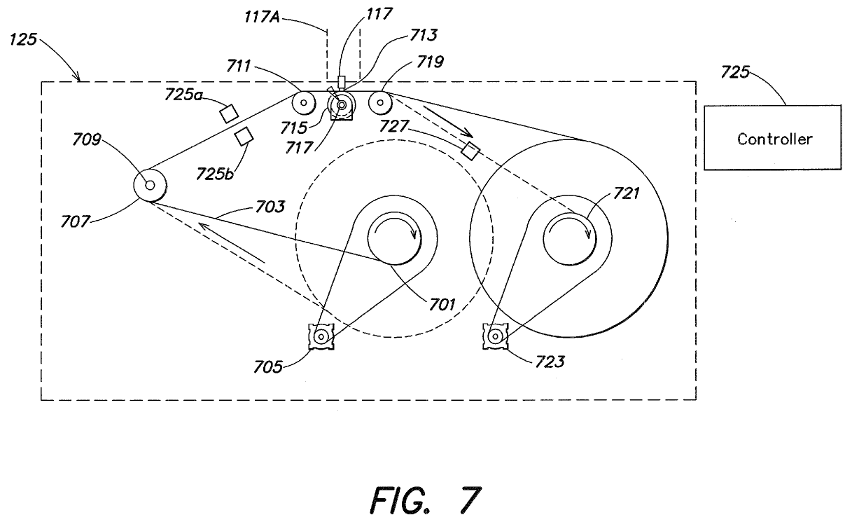

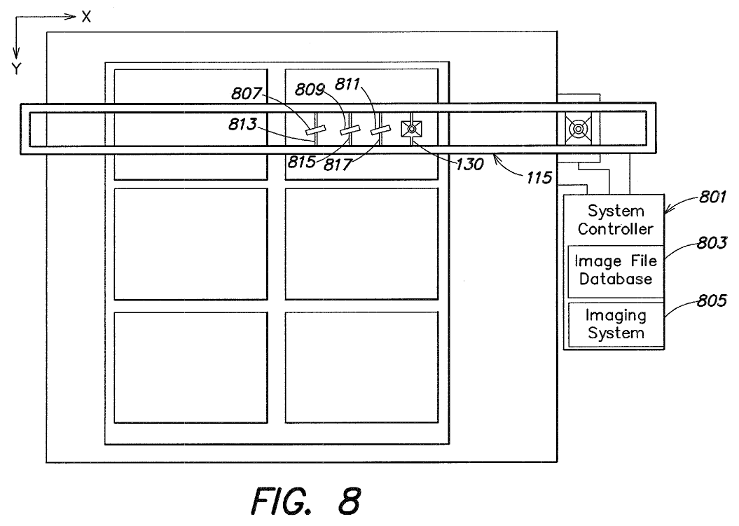

FIG. 7 illustrates an inkjet print head wiping station 125 in accordance with an embodiment of the present invention. With reference to FIG. 7, the inkjet print head wiping station 125, in an exemplary embodiment, may include a feed roller 701 which initially carries a spool of a cleaning medium 703 and which may be driven by feed motor 705. Cleaning medium 703 may be passed over and tensioned by a tension roller 707, which may include a tension roller sensor 709. Cleaning media 703 may then be passed over an adjustment roller 711, which may adjust an approach angle of the cleaning medium 703 with respect to a nozzle plate 713 of the print head 117. The present methods, apparatus and systems enable the print head 117 to remain in a position normally employed to dispense ink on a display object 113 of a substrate 111 during cleaning.

The cleaning medium 703 may be moved proximate to the nozzle plate 713 by a pressure roller 715. Pressure roller 715 may include shaft encoder 717 to measure the rotational velocity of the pressure roller 715, which may be converted to a speed of the cleaning medium 703. The other rollers of the cleaning system 125 may be similarly configured. Cleaning medium 703 may then be passed over an idle roller 719 before being spooled on a take up roller 721, which may be driven by a take up motor 723. The cleaning system 125 may also include a controller 725 coupled to any of feed roller 701, feed motor 705, tension roller 707, tension roll sensor 709, adjustment roller 711, pressure roller 715, shaft encoder 717, idle roller 719, take up roller 721, take up motor 723, or any other part of cleaning system 125.

A cleaning medium breakage sensor 725 may be employed in the system 125 adjacent cleaning medium 703 to determine whether the cleaning medium 703 is damaged and/or broken during cleaning; and a feed roller empty sensor 727 may be disposed adjacent feed roller 701 to determine whether the feed roller 701 is empty or about to be empty. The cleaning medium sensor 725 and/or feed roller empty sensor 727 also may be coupled to the controller 725.

In the exemplary embodiment, the feed roller 701 may initially hold a spool or roll of cleaning medium 703. In some embodiments, the feed roller 701 may be formed from Teflon® and/or aluminum and have a diameter of about 3 to 4 inches, although other materials and/or sizes may be used. Cleaning medium 703 may be threaded from the feed roller 701 over the tension roller 707, adjustment roller 711, pressure roller 715, and idle roller 719 to be wrapped onto take up roller 721. In some embodiments, fewer or more rollers may be employed. For example, in at least one embodiment, the tension roller 707 and idle roller 719 may be eliminated.

The cleaning medium 703 may be any material suitable for use in wiping the nozzle plate 713 or other surface of a print head 117, such as a particle free medium, and may contain a cleaning fluid (e.g., water or solvent) suitable for cleaning inkjet print heads. For example, the cleaning medium 703 may be 100% non-woven polyester, such as SatWipes C3 Wiper manufactured by Contec, Inc. of Spartanburg, S.C. In some embodiments a solvent (e.g., PGMEA (propylene glycol methyl ether acetate), acetone, etc.) or other cleaning fluid may be sprayed (e.g., via a spray nozzle) or otherwise deposited onto the cleaning medium 703. In the same or other embodiments, the cleaning fluid may be deposited directly onto the inkjet print head 117.

In some embodiments, the tension roller 707 may be formed from Teflon® and/or aluminum and have a diameter of about one inch, although other materials and/or sizes may be used. The tension of the cleaning medium 703 may be measured via the tension sensor 709. This information may be relayed to controller 725. The relative position and angle of tension roller 707 may be adjusted based on the determined tension (e.g., manually or automatically, such as under direction of the controller 725) to achieve a desired tension of the cleaning medium 703. In at least one embodiment, tension of the cleaning medium 703 may be approximately 50 to 1000 grams, although any appropriate tension may be used. In the same or alternative embodiments, tension may be determined in part by measuring motor torque of feed motor 705 and/or take-up motor 723.

The adjustment roller 711 may be adjustable so as to change an angle of approach of the cleaning medium 703 with respect to the nozzle plate 713. It may be desirable to achieve as small an approach angle as possible, preferably about 15 degrees or less, so as to maintain a substantially parallel planar relationship between the nozzle plate 713 and the cleaning medium 703 at the point of contact. The approach angle may be adjusted such that the maximum wiping occurs without shaving the nozzle plate 713 or causing misalignment of print head 117. Shaving may result from the cleaning medium 703 contacting a leading edge of the nozzle plate 713 causing particle generation.

In at least one embodiment, the adjustment roller 711 may be formed from Teflon® and/or aluminum and have a diameter of about one inch. Other adjustment roller materials and/or sizes may be used.

In some embodiments, the position of the adjustment roller 711 may be adjustable (e.g., by adjustment of a supporting block (not shown)) to compensate for tension variations resulting from changes in the geometry of the cleaning medium 703 path over the tension roller 707 as the roll of cleaning medium 703 is transferred from the feed roller 701 to the take up roller 721. In the same or alternative embodiments, the position of the adjustment roller 711 may also be adjustable to compensate for variations in the thickness of cleaning medium 703 or any offset in the position of inkjet print head 117. Additionally, the position of the adjustment roller 711 may be adjustable to improve clearance so that a parking station (not shown) may be moved to the inkjet print head 117 to a parking station (not shown) when the print head is not in use. In an exemplary embodiment, with the adjustment roller 711 set to about a two degree approach angle and the pressure roller 715 retracted away from the cleaning station, a clearance of approximately 2.3 mm, less cleaning medium 703 thickness, may be provided.

During the cleaning operation, cleaning station 125 may be located at the inkjet print head 117. The cleaning station 125 may be capable of housing a single inkjet print head 117, a row of inkjet print heads 117, an array of inkjet print heads 117, or any other suitable amount and/or arrangement of inkjet print heads 117. In an exemplary embodiment, cleaning station 125 may be a structure adapted to hold an inkjet print head or heads 117 in a particular location.

The pressure roller 715 may be biased toward the nozzle plate 713 using a spring loaded assembly or similar biasing mechanism. The pressure roller 715 may be movable via the biasing mechanism to move the cleaning medium 703 proximate to the nozzle plate 713 of the inkjet print head 117 located at cleaning station. In the same or alternative embodiments, the pressure roller 715 may be adjustable about a central axis to maintain a substantially parallel planar relationship between the nozzle plate 713 and the cleaning medium 703. In a preferred embodiment, pressure roller 715 may be formed from a material with some softness, such as Teflon® and/or aluminum and have a diameter of approximately 3 inches. In other embodiments, the pressure roller 715 may have a diameter of between about 16 and 20 mm. Larger or smaller pressure roller diameters may be used, as may other pressure roller materials.

Idle roller 719 may be used to guide cleaning medium 703 and adjust the departure angle of the cleaning medium 703 with respect to the nozzle plate 713 (in a manner similar to how adjustment roller 711 adjusts approach angle). Idle roller 719 may also be used to adjust a tension in cleaning medium 703, and may be of a similar size and material as the adjustment roller 711 (although other sizes and/or materials may be used). The idle roller 719 may be stationary and adjustable in position.

As stated, cleaning medium 703 may be wrapped onto take up roller 721 after use in the inkjet print head cleaning system 125. Take up roller 721 may be driven by take up motor 723. Take up motor 723 may be a belt driven motor, although any other suitable motor may be used. Take up roller 721 may be of a similar size and material as feed roller 701, although other sizes and/or materials may be used.

The controller 725 may be operably connected to the feed motor 705, take up motor 723, tension sensor 709, or any other part of the cleaning system 125. Controller 725 may be any suitable computer or computer system, including, but not limited to, a mainframe computer, a minicomputer, a network computer, a personal computer, and/or any suitable processing device, component, or system. Likewise, the controller 725 may comprise a dedicated hardware circuit or any suitable contribution of hardware and software.

In at least one embodiment, the controller 725 may monitor feed roll size, torque, and/or rotational speed, take up roll size, torque, and/or rotational speed, cleaning medium tension, cleaning medium distance traveled, and/or cleaning media speed. Controller 725 may utilize this information to control the various attributes and components of the system 125 so as to ensure a functional cleaning process. For example, in an exemplary embodiment, controller 725 may monitor tension, speed, and the distance traveled of the cleaning medium 703 as well as the size of the cleaning medium rolled onto feed roll 701 and take up roll 721. As tension is measured by tension sensor 709, this information may be used by the controller 725 to adjust the speed of the feed motor 705 or take up motor 723 (e.g., to keep an approximately constant tension on cleaning medium 703). As the speed of the cleaning medium 703 is monitored, the speeds of both the take up motor 705 and feed motor 723 may be adjusted (e.g. to keep the cleaning medium 703 traveling at an approximately constant speed). Similarly, information about the cleaning medium 703 distance traveled and the size of the cleaning medium 703 rolls on feed roll 701 and take up roll 721 may be used to determine and/or adjust the take up motor 705 speed and feed motor 723 speed (e.g., to affect cleaning medium speed and/or tension). In another embodiment, the speed and distance traveled of the cleaning medium 703, the feed motor 705 torque, and the size of the cleaning medium 703 rolls on feed roll 701 and take up roll 721 may be known, measured, and/or adjustable by controller 725. Cleaning medium 703 speed may be used by the controller 725 to adjust take up motor 723 speed. Feed motor 705 torque may be used by the controller 725 to adjust feed motor 705 torque. Similarly, the diameter of the cleaning medium 703 on either or both of the feed roller 701 and the take-up roller 721 may be used in conjunction with a measured motor torque on either or both of the feed motor 705 and the take-up motor 723 by the controller 725 to control the cleaning medium 703 tension. The motor torque of the feed motor 705 and/or the take-up motor 723 may be inversely proportional to the measured cleaning medium 703 diameter when cleaning medium 703 tension is kept constant.

Cleaning medium breakage sensor 725 is adapted to determine a defect in the cleaning medium 703. In a preferred embodiment, breakage sensor 725 may be disposed between the tension roller 707 and adjustment roller 715 although other locations may be used. In some embodiments, breakage sensor 725 may be an optical sensor that detects the presence or absence of the cleaning medium 703 (e.g., via reflection or a through beam) or may be any other suitable sensor or device. For example, the breakage sensor 725 may include a light beam source 725a and a detector 725b that only detects a light beam from the light beam source 725a when the clean medium 703 is not present or improperly positioned between the light beam source 725a and detector 725b. Absence of the cleaning medium 703, or a change in the transmission characteristics through the cleaning medium 703, may indicate a defect (e.g., breakage of the cleaning medium 703, improper cleaning medium type, etc.)

Feed roller empty sensor 727 may be disposed adjacent feed roller 701 and be adapted to monitor the roll size of cleaning medium 703 on the feed roller 701. For example, the feed roller empty sensor 727 may include a light source adapted to transmit a light beam toward a detector (not shown) that detects the light beam only if the diameter of cleaning medium 703 on the feed roller 701 is below a predetermined size (e.g., indicating the feed roller 701 is or is about to be empty). Other feed roller empty sensors may be used including, for example, a sensor that measures the weight of the feed roller 701 to determine the amount of cleaning medium 703 on the feed roller 701 or a reflected ultrasound or laser sensor. As cleaning medium 703 pays out during a cleaning process, the roll size (diameter) may be monitored to prevent running out of cleaning medium 703 during the cleaning process. In one embodiment, a feed roller empty sensor 727 may be mounted perpendicular to the feed roller 701.

If a designated cleaning medium 703 roll-change point is desired, a discrete-output sensor may be used, such as the light source/detector embodiment described above. In another embodiment, the feed roller empty sensor 727 may be adapted to measure how much cleaning medium 703 has been payed out by the feed roller 701 and configured and/or programmed with a specific distance which corresponds to a low supply condition, at which point the output of the feed roller empty sensor 727 changes state. If a continuous inventory is desired, an analog-output sensor may be used. Feed roller empty sensor 703 may be taught a distance which corresponds to the full roll, and a distance to the empty roll. As the cleaning medium 703 pays out, the sensor may send an analog signal that is scaled to represent the shrinking size of the roll. Any other suitable sensor may be used.

Feed roller empty sensor 727 may also be used to measure a diameter of the cleaning medium 703 mounted on feed roller 701. The diameter of the cleaning medium 703 may be used by the controller 725 to control tension of the cleaning medium 703.

FIG. 8 illustrates an inkjet print head calibration system 127 in accordance with an embodiment of the present invention. With reference to FIG. 8, the inkjet print head calibration system 127 of an inkjet printing system 101 of the present invention, in an exemplary embodiment, may include a system controller 801, an image file database 803, and an imaging system 805. Both the image file database 803 and the imaging system 805 may be integral components of the system controller 801 or both the image file database 803 and the imaging system 805 may be separate external devices. The image file database 803 may store data adapted to be used by the system 101 to print an image. The system controller 801 may be logically (e.g., electrically) and/or mechanically coupled to the print head support or bridge 115.

In the exemplary embodiment of FIG. 8, the print head support 115 includes three print heads 117. Although only three print heads 807, 809, 811 are shown in FIG. 1, it is important to note that any number of print heads may be mounted on and/or used in connection with the print head support 115. The print head support 115 may include motors, carriages, and/or other drive mechanisms 813, 815, 817 to move (e.g., laterally and/or rotationally) the print heads 807, 809, 811. The system controller 801 may be coupled to the print head support 115 and to each of the drive mechanisms 813, 815, 817, and print heads 807, 809, 811 so as to control and monitor the operation and movement of each of the print heads 807, 809, 811. The system controller 801 may control any and all imaging system 805 functions.

In an exemplary embodiment, the image file database 803 may contains data and/or information regarding any of the substrate (111 in FIG. 1) and/or display objects (113 in FIG. 1) which may be manufactured using the system 101. The image file database 803 may, for example, include information which may be utilized by the system controller 127 to control the movement as well as the printing operations of each of the print head support 115, the drive mechanisms 813, 815, 817, the print heads 807, 809, 811, and the stage (103 in FIG. 1), so as to perform any and/or all requisite printing passes over the display objects 113 and/or substrate 111. The system controller 801 may, for example, control the entire printing operation on and for any given display object 113 and/or substrate 111 by utilizing information stored in the image file database 803.

The inkjet printing system 101 according to the present invention may also include a camera 819 (e.g., as part of the inkjet print head calibration system 127. In some embodiments, the camera 819 may be mounted to a frame (not pictured) of the stage 103. However, in accordance with embodiments of the present invention, the camera 819 may be mounted to the platform 131. Therefore, the platform 131 may move the inkjet print head calibration system 127 to a print head 807, 809, 811 while the print head 807, 809, 811 is in a position normally employed to dispense ink on a display object 113 of the substrate 111. The camera 819 may include an imaging system and/or may be coupled to the system controller 801 that may include software to implement an imaging system 805 within the system controller 801. The camera 819 may be mounted (e.g., on the platform 131 at or below the level of the substrate support surface of the stage 103 and aimed upward so as to be able to automatically focus on and capture images of the bottom of the print heads 807, 809, 811. In some embodiments, the camera 819 may be positioned below an opening in the substrate support surface of stage 103.

An example of a camera 819 including an imaging system 805 that may be suitable for use with the present invention may include the model CDC-200 Camera coupled to a model MVS-8100D Frame Grabber and associated software commercially available from Cognex Corporation of Natick, Mass. In some embodiments, the camera 819 may include an automatic focus feature, a 100× to 200× zoom lens (e.g., a microscope lens), computer interface logic, and/or automation software. Other camera and/or camera systems including analog and/or digital CCD-based cameras or any other suitable sensor and/or detector device may be used.

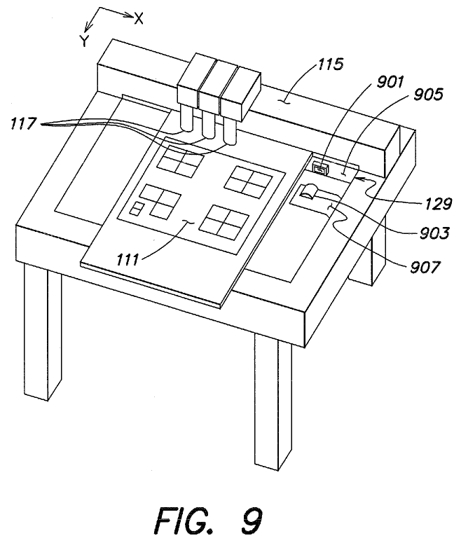

FIG. 9 illustrates an inkjet droplet visualization system 129 in accordance with an embodiment of the present invention. With reference to FIG. 9, the droplet visualization system 129 includes a droplet visualization device 901 that takes images of droplets dispensed from the inkjet print heads 117, a pulsed light 903 that flashes at a controlled frequency for a controlled duration, an image analyzer, a processor, and a visualization system controller. In embodiments of the present invention, the drop droplet visualization device 901 and the pulsed light 903 may be placed on the platform 131. Before the inkjet print heads 117, dispense droplets on a substrate (111 in FIG. 1), they first dispense droplets in a “gutter” between the visualization device 901 and the pulse light 903 to verify the sizes, the speeds and the trajectories of the droplets. This process is called the inkjet droplet verification process. The dispensed droplets during this verification process are contained by a collection plate (not shown), placed between and below the visualization device 901 and the pulse light 903. After the sizes, the speeds and the trajectories of the droplets are verified to be within the process specification, the inkjet print heads 117 are then allowed to dispense droplets on the substrate 111. If the sizes, the speeds, and the trajectories of the dispensed droplets are found to be out of the process specification during the verification process, the inkjet print heads 117 are adjusted until the sizes, the speed, and the trajectories are within specification.

In one embodiment, the visualization device 901 is a charge coupled device (CCD) camera. Since the droplet size is quite small, about 2 μm to about 100 μm in diameter, a telescope zoom lens is required. The visualization device 901 should have high resolution as well to increase the resolution of droplet detection, for example at least 1024×768 pixels. The camera can also be equipped with a motorized zoom and focus device (not shown). Other camera types and/or resolutions may also be used. In some embodiments, the camera 901 is mounted on a structure 905, which is coupled to the stage 115. The structure 905 may also be coupled to the stage 115. In one embodiment the position, including height and the mounted angle, of the visualization device 901 can be adjusted to align with the trajectories of the dispensed droplets. In another embodiment, the visualization device 901, also includes a microscope (not shown), which the camera can be attached to the viewfinder of the microscope so to record images obtained at the viewfinder of the microscope. The field of view of the camera 901 should be between about 0.1 mm to about 5 mm, and the field of depth of the camera 901 should be between about 0.05 mm to about 5 mm to take images of droplets, whose sizes are between about 2 μm to about 100 μm in diameter.

The light 903 could to be a nanosecond pulsed laser to illuminate the continuously generated flying droplets. Laser light is chosen to the preferred light source due to its faster and more accurate on/off control and also due to its finite directionality. Fast and accurate on/off control of the light source is important in this application and the finite directionality of the laser beams would make the images of the droplets more clear. A relatively high power pulsed laser is required in order to ensure sufficient image intensity to be achieved within short illumination pulse. In one embodiment, the power of the laser light is between about 0.001 mW to about 20 mW. In one embodiment, two images of a droplet are taken in one image frame to calculate the speed of the droplets by firing the laser pulse twice with a controlled interval so that the droplet has not traveled outside the field of view. The distance between the two images can be used to measure the distance the droplet traveled during the time between the two pulses are taken. For a droplet traveling at a speed between about 8 m/s to be captured on a camera with a field of view between about 0.1 mm to about 5 mm, the laser light 903 need to be pulsed at less than 200 microseconds time interval. In one embodiment, the laser light 903 is mounted on a structure 907. The distance between the visualization device 901 and the laser light 903 can be adjusted by moving either the structure 905 or structure 907.

The foregoing description discloses only exemplary embodiments of the invention. Modifications of the above disclosed apparatus, system and methods which fall within the scope of the invention will be readily apparent to those of ordinary skill in the art. For instance, although maintenance, such as inkjet print head cleaning and calibration are described above, the present methods, apparatus and systems may include maintenance units 121 adapted to perform other types of system maintenance, repair, and/or replacement or damaged or worn parts.

Accordingly, while the present invention has been disclosed in connection with exemplary embodiments thereof, it should be understood that other embodiments may fall within the spirit and scope of the invention, as defined by the following claims.

The invention claimed is:

1. A method of inkjet printing system maintenance, comprising:
moving a maintenance unit to an inkjet print head that is in a position normally employed to dispense ink on a display object of a substrate; and
performing maintenance to the inkjet print head selected from the group including cleaning the inkjet print head, calibrating the inkjet print head, and combinations thereof.

2. The method of claim 1 wherein moving the maintenance unit to the inkjet print head that is in a position normally employed to dispense ink on the display object of the substrate includes moving the maintenance unit in approximately the same direction that the substrate is moved during printing.

3. The method of claim 1 wherein moving the maintenance unit to the inkjet print head that is in a position normally employed to dispense ink on the display object of the substrate includes:
placing the maintenance unit on a movable platform; and
moving the platform below the inkjet print head that is in a position normally employed to dispense ink on the display object of the substrate such that the maintenance unit is moved to the inkjet print head.

4. The method of claim 3 wherein moving the platform below the inkjet print head includes moving the platform in approximately the same direction that the substrate is moved during printing.

5. The method of claim 1 wherein performing maintenance to the inkjet print head selected from the group including cleaning the inkjet print head, calibrating the inkjet print head, and combinations thereof includes employing the maintenance unit to provide a solvent shower or pool into which the inkjet print head is dipped such that ink on the inkjet print head is removed.

6. The method of claim 1 wherein performing maintenance to the inkjet print head selected from the group including cleaning the inkjet print head, calibrating the inkjet print head, and combinations thereof includes employing the maintenance unit to position and move a cleaning medium adjacent the inkjet print head such that ink may be removed from the inkjet print head.

7. The method of claim 1 wherein performing maintenance to the inkjet print head selected from the group including cleaning the inkjet print head, calibrating the inkjet print head, and combinations thereof includes employing the maintenance unit to calibrate a position and orientation control mechanism of the inkjet print head.

8. The method of claim 1 wherein performing maintenance to the inkjet print head selected from the group including cleaning the inkjet print head, calibrating the inkjet print head, and combinations thereof includes employing the maintenance unit to adjust at least one of the consistency and precision with which droplets of the ink are dispensed from the inkjet print head.

9. An inkjet printing apparatus, comprising:
a bridge positioned over a substrate support stage;
a plurality of inkjet print heads coupled to the bridge; and
a maintenance unit movable below the inkjet print heads, the maintenance unit having one or more stations selected from the group including a cleaning station, a calibration station and combinations thereof.

10. The apparatus of claim 9 wherein the maintenance unit is further movable in approximately the same direction that the substrate is moved during printing.

11. The apparatus of claim 9 wherein the maintenance unit is further movable below the inkjet print head when the inkjet print head is in a position normally employed to dispense ink on the display object of the substrate such that the maintenance unit is moved to the inkjet print head.

12. The apparatus of claim 11 wherein the maintenance unit is further movable via a platform in approximately the same direction that the substrate is moved during printing.

13. The apparatus of claim 9 wherein the maintenance unit includes an inkjet print head parking station adapted to provide a solvent shower or pool into which the inkjet print head is dipped such that ink on the inkjet print head is removed.

14. The apparatus of claim 9 wherein the maintenance unit includes a wiping station adapted to position and move a cleaning medium adjacent the inkjet print head such that ink may be removed from the inkjet print head.

15. The apparatus of claim 9 wherein the maintenance unit includes an inkjet print head calibration system adapted to calibrate a position and orientation control mechanism of the inkjet print head.

16. The apparatus of claim 9 wherein the maintenance unit includes an inkjet droplet visualization system adapted to adjust at least one of the consistency and precision with which droplets of the ink are dispensed from the inkjet print head.

17. A system for inkjet printing apparatus maintenance, comprising:
a substrate support stage; and
an inkjet printing apparatus coupled to the substrate support stage and, having:
a bridge positioned over the substrate support stage;
a plurality of inkjet print heads coupled to the bridge; and
a maintenance unit movable below the inkjet print heads, the maintenance unit having one or more stations selected from the group including a cleaning station, a calibration station and combinations thereof.

18. The system of claim 17 wherein the maintenance unit is further movable in approximately the same direction that the substrate is moved during printing.

19. The system of claim 17 wherein the maintenance unit is further movable below the inkjet print head when the inkjet print head is in a position normally employed to dispense ink on the display object of the substrate such that the maintenance unit is moved to the inkjet print head.

20. The system of claim 19 wherein the maintenance unit is further movable via a platform in approximately the same direction that the substrate is moved during printing.

21. The system of claim 17 wherein the maintenance unit includes an inkjet print head parking station adapted to provide a solvent shower or pool into which the inkjet print head is dipped such that ink on the inkjet print head is removed.

22. The system of claim 17 wherein the maintenance unit includes a wiping station adapted to position and move a cleaning medium adjacent the inkjet print head such that ink may be removed from the inkjet print head.

23. The system of claim 17 wherein the maintenance unit includes an inkjet print head calibration system adapted to calibrate a position and orientation control mechanism of the inkjet print head.

24. The system of claim 17 wherein the maintenance unit includes an inkjet droplet visualization system adapted to adjust at least one of the consistency and precision with which droplets of the ink are dispensed from the inkjet print head.
